(19) United States
(12) Patent Application Publication
(10) Pub. No.: US 2024/0165742 A1
(43) Pub. Date: May 23, 2024

(54) LASER-BASED DEEP WELDING METHOD

(71) Applicant: AUDI AG, Ingolstadt (DE)

(72) Inventors: Daniel BÖHM, Neuenstadt (DE); Markus GRETZER, Eichstätt (DE); Jan-Philipp WEBERPALS, Abstatt (DE)

(73) Assignee: AUDI AG, Ingolstadt (DE)

(21) Appl. No.: 18/549,946

(22) PCT Filed: Apr. 21, 2022
(86) PCT No.: PCT/EP2022/060476

§ 371 Date: Sep. 11, 2023

(30) Foreign Application Priority Data
May 25, 2021 (DE) 10 2021 113 430.7

(51) Int. Cl. B23K 26/244; B23K 26/06; B23K 26/32; B23K 103/04

(52) U.S. Cl. CPC B23K 26/244; B23K 26/0608; B23K 26/0617; B23K 26/0626; B23K 26/32; B23K 2103/04

(57) ABSTRACT

A method for laser-based deep welding of at least two parts to be joined, in which a laser beam device generates a laser beam with a deep welding laser beam component, which is moved at a feed rate along a joint. The deep welding laser beam component generates a vapor capillary in the material of the parts to be joined, which capillary is surrounded by a melt pool and which moves with the laser beam in the welding direction through the material of the parts to be joined, forming a capillary flow, in which a metal melt located at the capillary front flows via melt pool channels formed on both sides of the vapor capillary in the direction of the capillary rear side and solidifies there.

### FIELD

The invention relates to a method for laser-based deep welding of at least two parts to be joined.

### BACKGROUND

As an example, a bipolar plate of a fuel cell can be manufactured from two metal foils (for example steel foils) of very thin material thickness in the range of 75 μm. The two metal foils can be welded together by laser-based deep welding. This can result in very long weld seams of several meters.

In a generic method, a laser beam device generates a laser beam that has a deep welding laser beam component. The laser beam moves at a feed rate along a joint. In the method, the laser beam generates a vapor capillary in the joining parts material, which is surrounded by a melt pool. The vapor capillary moves together with the laser beam in the welding direction through the joining parts material. This occurs with formation of a capillary flow, in which a metal melt located at the capillary front flows through melt pool channels formed on both sides of the vapor capillary toward the rear side of the capillary and solidifies there.

In the prior art, when a critical feed rate is reached, periodic irregularities occur on the weld seam surface depending on further process parameters and the physical and geometric material properties. This effect is referred to as humping because it forms a structure of beads or small accumulations of material. Such a weld seam topography results in material deficiencies between the individual material accumulations, which partially lead to a weakening of the weld joint and thus to a higher probability of leakage between the two parts to be joined.

The above-mentioned critical feed rate, above which the hum-ping effect occurs, therefore represents a method limitation. For example, in the prior art, a feed rate in the range of 1000 mm/s for laser-based deep welding of thin steel foils (thickness at, for example, 75 μm) leads to the humping effect in the weld seam described above. A further increase in the feed rate results in an irregular weld topography.

DE 197 51 195 C1 discloses a method and a device for welding by means of laser radiation. Another device for laser processing is known from DE 10 2007 046 074 A1. From DE 10 2019 210 019 A1 an optical apparatus for laser welding of a workpiece is known. DE 10 2021 113 430 A1 discloses a method for laser-based deep welding. DE 11 2015 003 358 T5 describes an optimization of the weld pool shape in a joining method. From WO 99/06173 A1 a further method for welding by means of laser radiation is known. In addition, a publication by Blackbird et al dated Sep. 15, 2021 is known [T. Bautze-Scherff; D. Reitemeyer; N. Kaplan; V. Türetkan: Defect-free high speed welding of stainless steel foils by means of process-adapted intensity distribution, Kolloquium LKH2, Fraunhofer ILT, Aachen, 2021].

### SUMMARY

The object of the invention is to provide a method for laser-based deep welding of at least two parts to be joined, in which the occurrence of the humping effect in the weld seam can be reliably avoided despite high process speeds.

The invention is based on a method for laser-based deep welding of at least two parts to be joined. In the method, a laser beam device generates a laser beam with a deep welding laser beam component. The laser beam is moved at a feed rate along a joint. The laser beam generates a vapor capillary in the material of the parts to be joined, which is surrounded by a melt pool. The vapor capillary moves together with the laser beam in the welding direction through the material of the parts to be joined. This occurs with the formation of a capillary flow, in which a metal melt located at the capillary front flows through melt pool channels formed on both sides of the vapor capillary toward the rear side of the capillary and solidifies there.

The invention is based on the fact that in conventional laser-based deep welding, the melt pool channels formed on both sides of the vapor capillary have a small flow cross-section. The capillary flow therefore reaches a maximum flow velocity in the region of the weld pool channels. Due to the small flow cross-section at the sides of the vapor capillary (i.e., melt pool width minus vapor capillary diameter), the average velocity occurring there during capillary flow exceeds the feed rate during laser beam welding by a multiple, especially for materials with a small temperature difference between vaporization and solidification and low thermal conductivity.

According to the invention, it was recognized that in conventional laser-based deep welding, the maximum flow velocity in the lateral melt pool channels is a significant factor for the occurrence of the humping effect. Against this background, according to the characterizing part of claim 1, at least one melting laser beam component is additionally associated with the laser beam. The melting laser beam component increases the width, i.e. the flow cross-section, of the melting channels. This reduces the flow velocity of the metal melt flowing through the melt pool channels. Due to the reduced flow velocities in the lateral melt pool channels, the feed rate can be substantially increased compared to the prior art without the generation of a humping effect, i.e. of a periodic weld seam topography with alternating material deficits and material accumulations.

According to the invention, the flow velocity around the vapor capillary can therefore be reduced by targeted beam shaping of the laser beam, whereby the resulting upper limit of the feed rate above which the humping effect occurs can be increased. According to the invention, a closed weld seam can thus be joined at a significantly higher feed rate than is comparatively possible in the prior art, which uses a conventional round laser beam without beam shaping. The beam shaping or superimposition adapted according to the invention influences the formation of the melt pool in such a way that the flow cross-section at the sides of the vapor capillary is increased in order to reduce the average flow velocity occurring there during capillary flow.

It should be emphasized that the method according to the invention is not limited to the laser beam joining of two parts to be joined. Rather, the method according to the invention is also suitable for the production of a component composite consisting of several parts to be joined. It should also be emphasized that the method according to the invention can be used independently of the material thickness. This means that the method can be used to cover both applications with thicker materials, for example in car body construction, and applications with thin material thicknesses, for example approx. 50 μm to 200 μm, such as those occurring in laser joining of electrochemical components of an electrochemical system, for example in the case of bipolar plates of a fuel cell, battery cell components, components of a battery module, an overall battery system, an electrolyzer, a hydrogen compressor or the like.

In a first embodiment, the melt pool widening according to the invention, especially at the sides of the vapor capillary, can be achieved by exploiting lateral heat propagation by primarily conductive heat transport. In a second embodiment, the melt pool can be widened by targeted melting close to the surface, preferably in the manner of heat conduction welding.

In summary, according to the invention, the flow cross-section in the capillary flow is increased, whereby the feed rate can be significantly increased until the humping effect is reached. Similarly, the resulting thermal field (or temperature influence zone) can be influenced and the resulting thermal distortion can be kept low or controlled.

According to the invention, beam shaping can be achieved by adapting or increasing optical components in the operating means line in the laser beam source, via beam guidance in the optical fiber or directly in the processing optics. Examples of beam shaping in the optical fiber with regard to directional independence are fibers with concentric arrangements by, for example, core/sheath guiding of the radiation. In such an arrangement, the laser beam spot is divided into a radially inner core surface (hereinafter also referred to as core) and a radially outer ring or shell surface (hereinafter also referred to as ring or shell), which are aligned concentrically with respect to each other with the same center, with or without an intermediate geometric gap. Such a concentric arrangement is advantageous with regard to a preferably direction-independent laser beam guidance in the surface.

The superimposed power distribution (i.e. intensity, calculated as power/area) can be individually determined by the beam shaping principle applied before and/or during the processing method. In addition, it is conceivable for the application that the laser beam components are not concentric to each other with a common optical axis, but are offset from each other, i.e. off-center. Moreover, in addition to a round design of the laser beam components, other shapes such as ellipses, rectangles, etc. can be used.

The intensity can be specified once or adjusted over time during processing by selecting the sequence of operating means consisting of laser, fiber and optics. Possible exemplary embodiments:
Dual or multi-core fiber with one laser: in this case, the power ratio (between core and ring) is adjustable. In addition, the total power can be adjusted once or modulated over time.
Dual- or multi-core fiber with a corresponding number of lasers: In this case, core and ring can be adjusted independently before and/or during the processing, in terms of laser power, modulation, etc.
On the optical side via diffractive optical elements (DOE): In this case, a fixed geometry specification with restricted power distribution between ring and core (one or more DOEs required) can be modulated once or over time with absolute power specification by the laser source.
On the optical side via refractive optical elements: In this case, a fixed geometry specification with restricted power distribution between ring and core can be modulated once or over time with absolute power specification by the laser source. In addition, the beam axes of the laser beam components can be shifted relative to each other by the design of the element, for example by defocusing.

The laser beam and/or the laser beam components can each be realized as a round beam. In a first variant, the deep welding laser beam component and the melting laser beam component can be aligned in a concentric arrangement in a superimposed beam shaping, and in particular in a core/shell guide of the laser beam. In this case, a radially inner core with, in particular, a circular cross-sectional area forms the deep welding laser beam component and a radially outer shell with a circular ring-shaped cross-section forms the melting laser beam component.

By means of a process control of the laser beam device, in the case of the concentric arrangement, the diameter ratio of the two laser beam components and/or the power ratio of the two laser beam components can be adapted to the processing speed, so that a sufficiently large melt pool channel results for the capillary flow.

For the diameter ratio d₂/d₁, the following applies:

d₂≥d₁, and preferably

1≤d₂/d₁≤20, wherein

d₁=focal diameter of the deep welding laser beam component, and

d₂=focus outer diameter of the melting laser beam component.

Particularly preferably, the ratio of the two beam diameters is:

2.5≤d₂/d₁≤10, and most preferably.

2.5≤d₂/d₁≤4.

To provide such diameter ratios, a single-mode laser is preferred, with which such small focal diameters can be generated. The imaging is preferably performed via scanner optics, with an imaging ratio between 1 and 6, in particular between 2 and 4.

The power of the deep welding laser beam component can be changed by the process control in direct proportion to the feed rate. For example, if the feed rate is increased from 800 mm/s by a factor of 1.5 to 1200 mm/s, the power of the deep welding laser beam component can also be increased by the same factor. By means of the invention, feed rates of up to 1500 mm/s, in particular 2000 mm/s, can be achieved.

In the concentric arrangement indicated above, the power of the melting laser beam component (that is, in the annular, radially outer shell) can be reduced in comparison to the power of the deep welding laser beam component, and preferably to a value below a deep welding threshold. In this way, the melting temperature, but not the vapor temperature of the material of the parts to be joined (e.g. steel) is reached in the area of the melting laser beam component.

A beam shaping alternative to the superimposed beam shaping is described below: Accordingly, the laser beam can have a deep welding laser beam component and at least one melting laser beam component leading in the welding direction. Preferably, at least two leading melting laser beam components can be assigned to the deep welding laser beam component. In this case, the deep welding laser beam component can move along a joint longitudinal axis, while the two melting laser beam components are each offset by a transverse offset on both sides of the joint longitudinal axis. The center-to-center transverse distance a₂ between the two leading melting laser beam components can preferably correspond to at least the focal diameter d₁ of the deep welding laser beam component. In addition, the distance between the inner sides of the two leading melting laser beam components facing each other transversely to the longitudinal axis of the joint can be smaller than the focal diameter of the trailing deep welding laser beam component. This ensures an overlap between the partial melting baths of the total of three laser beam components.

As an example, the following can apply for a material thickness of the material of the parts to be joined in a range of, for example, 50 μm to 150 μm, in particular of 75 μm: The focal diameter of the deep welding laser beam component can be in a range of, for example, 40 μm to 100 μm, and in particular of 50 μm. For this purpose, a single-mode laser can preferably be used, with which such small focal diameters can be generated. The imaging is preferably carried out using scanner optics, namely with an imaging ratio between 1 and 6, in particular between 2 and 4.

During beam shaping with the two leading melting laser beam components, their distance from the trailing deep welding laser beam component can be reduced to a zero distance. At zero distance, the centers of the three laser beam components are aligned one behind the other in the transverse direction to the longitudinal axis of the joint.

The same applies for the power, as already described with reference to the concentric arrangement.

In another alternative beam shaping, exactly one melting laser beam component can be provided, which is aligned longitudinally with the trailing deep welding laser beam component in the welding direction. In this beam configuration, two process embodiments are encompassed by the invention:

1. The leading melting laser beam component may have a power that is reduced compared to the power of the deep welding laser beam component to a value below the deep welding threshold. The melting laser beam component therefore performs heat conduction welding, in which only near-surface melting takes place, but without vaporization of the material of the parts to be joined. The laser beam spots of the two laser beam components can have focal diameters such that the two spots at least touch or partially overlap each other. The center-to-center longitudinal distance between the two laser beam components is dimensioned to be greater than zero. The diameter ratio of the two laser beam components can be determined in analogy to the concentric arrangement. The power of the two laser beam components can also be set in analogy to the concentric arrangement.

2. In the second process embodiment, the leading melting laser beam component can be designed in such a way that it does not perform heat conduction welding but deep penetration welding. In this case, the diameter ratio d₂/d₁ at the two laser spots can be at least close to 1. By means of the process control, the center-to-center distance between the two laser beam components can be adjusted in such a way that the lateral temperature gradient is smaller than compared to a single beam or compared to two laser beam components with too large a distance. Depending on the feed rate, the process control can adjust the center-to-center distance as well as the powers of the two laser beam components, preferably in such a way that the width of the respective melt pool channel increases due to the lower temperature gradient.

In a further alternative beam shaping, the laser beam components arranged in longitudinal alignment one behind the other can form a line focus. This extends over a focus length along the welding direction. The width of the line focus corresponds to the focal diameter of the laser beam components.

The beam shaping that takes place within the scope of the invention can be generated by optical elements in the laser beam device, for example a prism, a diffractive or refractive optical element or other embodiments in the processing optics, preferably in the collimated beam path between the collimating lens and the focusing lens.

The beam splitting can be generated via parts or prisms, for example, and the line focus can be generated via cylindrical lenses, as an example.

The method can be used in particular for laser beam joining of components in an electrochemical system, such as battery cell components, components of a fuel cell, a battery module, a battery system, an electrolyzer, a hydrogen compressor or the like. In this case, superimposed sheet metal parts with a material thickness in particular in the range of, for example, 50 μm to 250 μm, or in the range of, for example, 250 μm to 500 μm can be joined together. Alternatively, other applications are also possible, for example in laser beam joining of superimposed sheet metal parts with a material thickness in the range of, for example, 250 μm to 500 μm.

The method can also be used for laser joining of components in car body construction. In this case, superimposed sheet metal parts as parts to be joined, with a material thickness of, for example, greater than 0.5 mm, in particular in the range from 0.5 mm to 5 mm, and particularly preferably in the range from 0.5 mm to 3 mm, can be joined together.

### BRIEF DESCRIPTION OF THE FIGURES

Examples of embodiments of the invention are described below with reference to the accompanying figures.

In particular:

FIG. 1 shows a view illustrating a welding process according to a first embodiment,

FIG. 2 shows another view illustrating a welding process according to a first embodiment,

FIG. 3 shows another view illustrating a welding process according to a first embodiment,

FIG. 4a shows another view illustrating a welding process according to a first embodiment,

FIG. 4b shows another view illustrating a welding process according to a first embodiment,

FIG. 4c shows another view illustrating a welding process according to a first embodiment,

FIG. 5 shows a view illustrating beam shaping according to further exemplary embodiments,

FIG. 6 shows a view illustrating beam shaping according to further exemplary embodiments, and

FIG. 7 shows a view illustrating beam shaping according to further exemplary embodiments.

### DETAILED DESCRIPTION

The method according to the invention is used to produce a composite of two or more sheet metal parts. In principle, the method can be used independently of the material thickness. This means that in addition to an application, for example, in car body construction, applications with thin material thicknesses in the range of, for example, approx. 50 μm to 200 μm are also possible, such as in electrochemical components, for example, in bipolar plates of a fuel cell, in battery cell components, in components of a battery module, an overall battery system, an electrolyzer or a hydrogen compressor or the like.

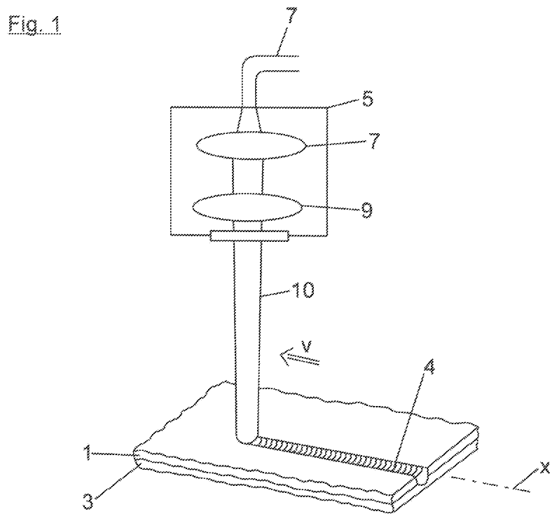

FIG. 1 shows a laser beam device by means of which two parts to be joined 1, 3 are welded together in a deep welding method. The two parts to be joined 1, 3 are material-thin steel foils, for example. The parts to be joined 1, 3 can be components of an electrochemical system, such as a fuel cell or a battery cell, or components of a battery module, an overall battery system, an electrolyzer or the like, for example.

It should be emphasized that the invention is not limited to specific material thicknesses of the parts to be joined 1, 3. By way of example, the superimposed parts to be joined 1, 3 can have a material thickness in particular in the range from, for example, 50 μm to 250 μm, or in the range from, for example, 250 μm to 500 μm. Alternatively, other applications are also possible, for example in laser beam joining of superimposed sheet metal parts with a material thickness in the range of, for example, 250 μm to 500 μm.

Moreover, the method is not limited to laser joining of components of an electrochemical system. Rather, the method can be used in any application, for example in laser joining of components of a car body construction. In this case, parts to be joined 1, 3 with a material thickness of, for example, greater than 0.5 mm, in particular in the range from 0.5 mm to 5 mm, especially preferably in the range from 0.5 mm to 3 mm, can be joined together.

In the deep welding method, the laser beam device is moved in a welding direction at a feed rate v, as a result of which a weld seam 4 is formed which joins the two parts to be joined 1, 3 together in a fluid-tight manner.

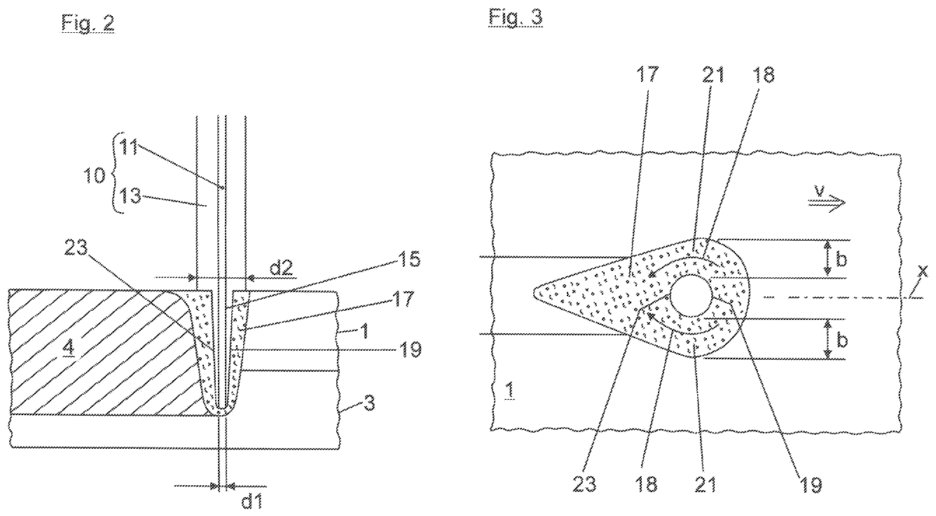

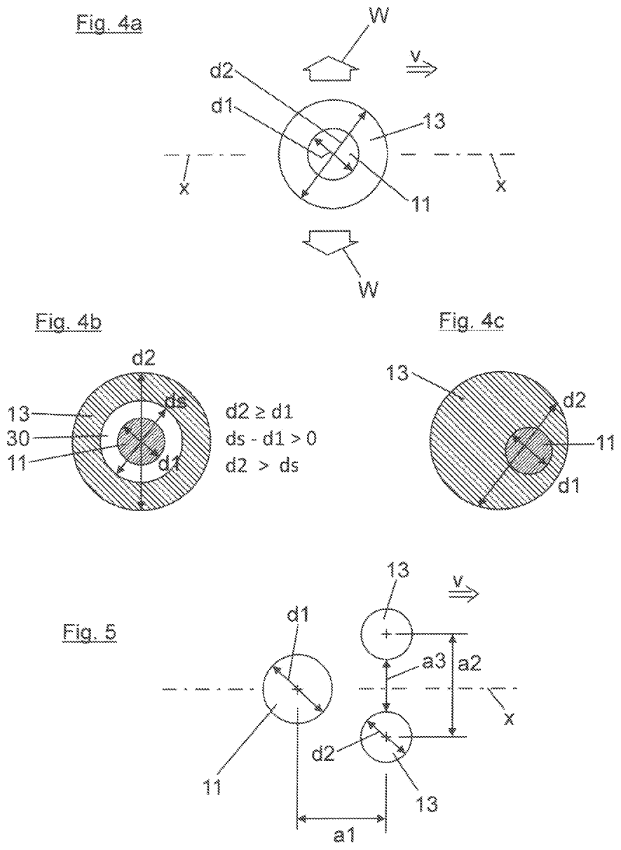

In FIG. 1, the laser beam device has a processing optics 5 with an optical fiber 7. The processing optics 5 consists of a collimating optics 7 and a focusing optics 9. In the processing optics 5, a superimposed beam shaping of the laser beam 10 takes place. By means of the superimposed beam shaping, a deep welding laser beam component 11 and a melting laser beam component 13 are aligned in a concentric arrangement, as can be seen in FIGS. 2 and 4. In the concentric arrangement, a core/shell guide of the laser beam 10 is implemented in which a radially inner core with a circular cross-sectional area forms the deep welding laser beam component 11 and a radially outer shell with a circular ring-shaped cross-section forms the melting laser beam component 13.

As shown in FIG. 2, a vapor capillary 15 surrounded by a melt pool 17 is created in the joining part tool by means of the deep welding laser beam component 11. The vapor capillary 15 moves with the laser beam 10 in the welding direction through the material of the parts to be joined. This results in a flow around the capillary 17, indicated by arrows in FIG. 3, in which a metal melt located at the capillary front 19 flows through melt pool channels 21 formed on both sides of the vapor capillary 15 in the direction of the rear side of the capillary 23 and solidifies there.

With the aid of the melting laser beam component 13, targeted melting takes place close to the surface in the manner of heat conduction welding. This produces a widening of the melt pool, which increases the width b (FIG. 3) and thus the flow cross-section of the melt pool channels 21. In this way, the flow velocity of the metal melt flowing through the melt pool channels 21 is reduced. Due to the reduced flow velocities in the lateral melt pool channels 21, the feed rate can be increased substantially compared to the prior art without a humping effect occurring, i.e. a periodic weld topography with alternating material deficits and material accumulations.

In FIGS. 1 to 4, the laser beam 10 and the two laser beam components 11, 13 are each implemented as a round beam. A process control of the laser beam device can adjust the diameter ratio d₂/d₁ as well as the power ratio P₁/P₂ between the two laser beam components 11, 13 depending on the feed rate v, where:

d₂≥d₁, as well as

1≤d₂/d₁≤20, where

d₁=the focal diameter of the deep welding laser beam component 11

d₂=the focal outer diameter of the melting laser beam component 13.

P₁=power of the deep welding laser beam component 11.

P₂=power of the melting laser beam component 13.

For example, with a material thickness of the material of the parts to be joined of 50 μm, the focal diameter d₁ of the deep welding laser beam component 11 can be 75 μm.

In FIGS. 1 to 4, the power P₂ of the melting laser beam component 13 is reduced to a value below a deep welding threshold in comparison with the power P₁ of the deep welding laser beam component 11. The melting laser beam component 13 therefore reaches the melting temperature, but not the vapor temperature of the material of the parts to be joined. The power P₂ of the melting laser beam component 13 is set in such a way that only the piece surface is melted. When dimensioning the power P₂ of the melting laser beam component 13, the thermal influence by the power P₁ of the deep welding laser beam component 11 is taken into account.

Examples of beam shaping in the optical fiber are fibers with a concentric arrangement without or with a geometric gap (that is, annular gap 30) between core and ring. Variable quantities here are, in the case of the concentric arrangement, the diameter ratio d₂/d₁. In this case, the following applies: d2≥d1(d2: outer diameter of ring, d1: outer diameter of core), wherein the following applies preferably: 1≤d2/d1≤20. FIG. 4a shows the condition for the geometric distance ds−d1=0. This is thus not present and is present in a fiber with a refractive index difference at the interface. In FIG. 4b, the geometric spacing (i.e., the annular gap 30) is described as ds−d1>0 and d2≥ds (ds: annular gap outer diameter).

Likewise, the P2/P1 power ratio can be adapted to the process and, in particular, to the process speed so that a sufficiently large melt pool channel 21 is formed for the capillary flowing around it.

In addition, any configurable matrix arrangement is conceivable: for example, in FIG. 4c the core and the ring are no longer aligned concentrically to each other, but are offset from each other, although the core is still completely surrounded by the ring. The configurations shown in FIGS. 4a to 4c follow the approach that the outer radiation component 13 widens the melt pool 17 by melting close to the surface (heat conduction welding regime).

In addition to fibers, all beam configurations can be generated by optical elements such as a prism, a diffractive or refractive optical element, or other features in the processing optics, preferably in the collimated beam path between the collimating lens and the focusing lens.

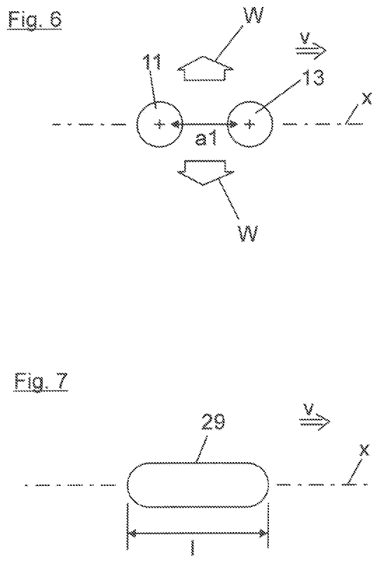

In the following, FIGS. 5 to 7 show alternative beam shapes according to further embodiments. In FIGS. 5 to 7, the laser beam components 11, 13 are each implemented as single round beams, of which only the laser spots forming at the joint are shown in FIGS. 5 to 7.

FIG. 5 shows a second exemplary embodiment in which the laser beam 10 is split by beam shaping into a trailing deep welding beam component 11 and two leading melting beam components 13. Accordingly, the deep welding laser beam component 11 moves along a joint longitudinal axis x, while the two leading melting laser beam components 13 are offset from the joint longitudinal axis x by a transverse offset on both sides. The longitudinal center-to-center distance a₁ between the trailing deep welding laser beam component 11 and the two leading melting laser beam components 13 is greater than zero and is dimensioned such that the partial melt pools generated by the laser beam components 11, 13 merge into a common melt pool. By way of example, the laser beam components 11, 13 can touch each other at least tangentially with their laser spots or partially overlap each other. The center-to-center transverse distance a₂ between the two leading melting laser beam components 13 can correspond at least to the focal diameter d₁ of the deep welding laser beam component 13. In addition, in FIG. 5, a distance a₃ between the facing inner sides of the two melting laser beam components 13 can be smaller than the focal diameter d₁ of the deep welding laser beam component 11. In this way, an overlap between the partial melting pools of the two leading melting laser beam components 13 and the deep welding laser beam component 11 is ensured.

In a view corresponding to FIGS. 4 and 5, FIG. 6 shows a third exemplary embodiment in which the laser beam 10 is split into a trailing deep welding laser beam component 11 and a leading melting laser beam component 13 by beam shaping. In FIG. 6, the two laser beam components 11, 13 are arranged in longitudinal alignment one behind the other.

In a first process variant, the melting laser beam component 13 in FIG. 6 can have a power P₂ which, compared to the power P₁ of the deep welding laser beam component 11, is reduced to a value below a deep welding threshold. In this way, the melting laser beam component 13 is used for heat conduction welding, which results in a widening of the melt pool by utilizing a lateral heat input W through primarily conductive heat transport. Increasing the distance a₁ increases the lateral heat input W and thus widens the melt pool 17 in the region of the vapor capillary 15. In a second process variant shown in FIG. 6, the leading melting laser beam component 13 can have a power P₂ which does not permit heat conduction welding but deep welding. The diameter ratio d₂/d₁ can be at least close to 1. In addition, the center-to-center longitudinal distance a₁ between the two laser beam components 11, 13 can be set so that the lateral temperature gradient is smaller than compared to a single beam or two laser beam components with a distance that is too large. The process control of the laser beam device can set the center-to-center longitudinal distance a₁ and the powers P₁, P₂ as a function of the feed rate v in such a way that the width of the respective melt pool channel 21 increases due to the small temperature gradient.

FIG. 7 shows a fourth exemplary embodiment in which the two laser beam components 11, 13 arranged in longitudinal alignment one behind the other form a line focus 29. This extends over a focus length 1 along the welding direction, its width corresponding to the focal diameters d₁, d₂ of the laser beam components 11, 13. The power P₁ of the trailing deep welding laser beam component 11 is dimensioned such that a deep welding process is possible. In addition, a power distribution along the longitudinal axis x is possible in the line focus 29.

Alternatively and/or additionally, in the exemplary embodiments of FIGS. 5 to 7, instead of the round beams shown, beams with beam shaping as shown in FIGS. 4a to 4c can also be used. In general, beams of any geometric shape can also be used in this case.

### LIST OF REFERENCE NUMERALS

1, 3 parts to be joined
4 weld seam
5 processing optics
7 collimation optics
9 focusing optics
10 laser beam
11 deep welding laser beam component
13 melting laser beam component
15 vapor capillary
17 melt pool
18 capillary flow
19 capillary front
21 melt pool channel
23 capillary rear side
25 deep welding laser spot
27 melting laser spot
29 line focus
x joint longitudinal axis
1 line focus length
b melt pool channel width
a₁ center-to-center longitudinal distance
a₂ center-to-center transverse distance
a₃ distance
V feed rate
W lateral heat input
d₁ focal diameter of the deep welding laser beam component 11
d₂ focal outer diameter of the melting laser beam component 13
P₁ power of the deep welding laser beam component 11
P₂ power of the melting laser beam component 13

1-10. (canceled)

11. A method for laser-based deep welding of at least two parts to be joined, in which a laser beam device generates a laser beam with a deep welding laser beam component, which is moved at a feed rate along a joint, wherein the deep welding laser beam component generates a vapor capillary in the material of the parts to be joined, which capillary is surrounded by a melt pool and which moves with the laser beam in the welding direction through the material of the parts to be joined, forming a capillary flow, in which a metal melt located at the capillary front flows via melt pool channels formed on both sides of the vapor capillary in the direction of the capillary rear side and solidifies there,
wherein the laser beam is additionally associated with at least one melting laser beam component by means of which the width, namely the flow cross section, of the melt pool channels is increased, whereby the flow velocity of the metal melt flowing through the melt pool channels is reduced.

12. The method according to claim 11, wherein the laser beam and/or the laser beam components are each realized as a round beam, and/or in that the deep welding laser beam component and the melting laser beam component are aligned in a concentric arrangement in a superimposed beam shaping, and in particular in a core/shell guide of the laser beam, in which a radially inner core with, in particular, a circular cross-sectional area, forms the deep welding component, and a radially outer shell of circular cross-section forms the melting component, and/or in that, in particular, the melt pool widening occurs by a targeted melting close to the surface, preferably in the manner of heat conduction welding.

13. The method according to claim 11, wherein the laser beam device has a process control which adapts a diameter ratio and/or a power ratio between the two laser beam components as a function of the feed rate, and the following applies to the focal diameter of the deep welding laser beam component and the focal diameter of the melting laser beam component:
d₂≥d₁, and
1≤d₂/d₁≤20, preferably
2.5≤d₂/d₁≤10, most preferably
2.5≤d₂/d₁≤4,
and/or the melting laser beam component has a power which is reduced in comparison with the power of the deep welding laser beam component, and to a value below a deep welding threshold at which the melting temperature but not the vapor temperature of the material of the parts to be joined is reached.

14. The method according to claim 11, wherein, in the case of beam shaping, the laser beam has a deep welding laser beam component and at least one melting laser beam component leading in the welding direction, which are spaced apart from one another by a center-to-center longitudinal distance of greater than zero, and/or, the center-to-center longitudinal distance between the laser beam components is dimensioned in such a way that the partial melt pools generated by the laser beam components merge into a common melt pool, and/or the laser beam components at the joint at least tangentially touch or partially overlap one another, and/or, in particular, the laser beam components are arranged in longitudinal alignment one behind the other in the welding direction.

15. The method according to claim 14, wherein, among the two laser beam components arranged one behind the other in longitudinal alignment, the leading melting laser beam component is designed in such a way that it does not carry out heat conduction welding but deep welding, and, in particular, in that the diameter ratio is at least close to 1, and wherein, by the process control, the center-to-center longitudinal distance between the laser beam components can be adjusted in such a way that the lateral temperature gradient is smaller compared to a single beam, and/or the process control adjusts the longitudinal center-to-center distance and the powers as a function of the feed rate, preferably in such a way that the width of the respective melt pool channel increases as a result of the small temperature gradient.

16. The method according to claim 15, wherein both laser beam components arranged one behind the other in longitudinal alignment form a line focus which extends over a focus length in the welding direction and the width of which corresponds to the focal diameter of the laser beam components.

17. The method according to claim 14, wherein the deep welding laser beam component is associated with at least two leading melting laser beam components, and the deep welding laser beam component moves along a joint longitudinal axis, while the two melting laser beam components are each offset by a transverse offset on either side of the joint longitudinal axis, and the center-to-center transverse distance between the two melting laser beam components corresponds at least to the focal diameter of the deep welding laser beam component.

18. The method according to claim 17, wherein the distance between the inner sides of the leading melting laser beam components facing one another transversely to the longitudinal axis of the joint is smaller than the focal diameter of the deep welding laser beam component, so that an overlap is ensured between the partial melting baths of the two leading melting laser beam components and of the deep welding laser beam component.

19. The method according to claim 11, wherein with a material thickness of the material of the parts to be joined in a range of 50 μm to 150 μm, the focal diameter of the deep welding laser beam component lies in a range of 40 μm to 100 μm.

20. The method according to claim 11, wherein the process control of the laser beam device changes the power of the deep welding laser beam component directly proportionally to the feed rate, so that when the feed rate is increased from 800 mm/s by a factor of 1.5 to 1200 mm/s, the power of the deep welding laser beam component is increased by the same factor, and/or feed rates of up to 1500 mm/s are achievable.

21. The method according to claim 12, wherein the laser beam device has a process control which adapts a diameter ratio and/or a power ratio between the two laser beam components as a function of the feed rate, and the following applies to the focal diameter of the deep welding laser beam component and the focal diameter of the melting laser beam component:
d₂≥d₁, and
1≤d₂/d₁≤20, preferably
2.5≤d₂/d₁≤10, most preferably
2.5≤d₂/d₁≤4,
and/or the melting laser beam component has a power which is reduced in comparison with the power of the deep welding laser beam component, and to a value below a deep welding threshold at which the melting temperature but not the vapor temperature of the material of the parts to be joined is reached.

22. The method according to claim 12, wherein, in the case of beam shaping, the laser beam has a deep welding laser beam component and at least one melting laser beam component leading in the welding direction, which are spaced apart from one another by a center-to-center longitudinal distance of greater than zero, and/or, the center-to-center longitudinal distance between the laser beam components is dimensioned in such a way that the partial melt pools generated by the laser beam components merge into a common melt pool, and/or the laser beam components at the joint at least tangentially touch or partially overlap one another, and/or, in particular, the laser beam components are arranged in longitudinal alignment one behind the other in the welding direction.

23. The method according to claim 13, wherein, in the case of beam shaping, the laser beam has a deep welding laser beam component and at least one melting laser beam component leading in the welding direction, which are spaced apart from one another by a center-to-center longitudinal distance of greater than zero, and/or, the center-to-center longitudinal distance between the laser beam components is dimensioned in such a way that the partial melt pools generated by the laser beam components merge into a common melt pool, and/or the laser beam components at the joint at least tangentially touch or partially overlap one another, and/or, in particular, the laser beam components are arranged in longitudinal alignment one behind the other in the welding direction.

24. The method according to claim 15, wherein the deep welding laser beam component is associated with at least two leading melting laser beam components, and the deep welding laser beam component moves along a joint longitudinal axis, while the two melting laser beam components are each offset by a transverse offset on either side of the joint longitudinal axis, and the center-to-center transverse distance between the two melting laser beam components corresponds at least to the focal diameter of the deep welding laser beam component.

25. The method according to claim 16, wherein the deep welding laser beam component is associated with at least two leading melting laser beam components, and the deep welding laser beam component moves along a joint longitudinal axis, while the two melting laser beam components are each offset by a transverse offset on either side of the joint longitudinal axis, and the center-to-center transverse distance between the two melting laser beam components corresponds at least to the focal diameter of the deep welding laser beam component.

26. The method according to claim 12, wherein with a material thickness of the material of the parts to be joined in a range of 50 μm to 150 μm, the focal diameter of the deep welding laser beam component lies in a range of 40 μm to 100 μm.

27. The method according to claim 13, wherein with a material thickness of the material of the parts to be joined in a range of 50 μm to 150 μm, the focal diameter of the deep welding laser beam component lies in a range of 40 μm to 100 μm.

28. The method according to claim 14, wherein with a material thickness of the material of the parts to be joined in a range of 50 μm to 150 μm, the focal diameter of the deep welding laser beam component lies in a range of 40 μm to 100 μm.

29. The method according to claim 15, wherein with a material thickness of the material of the parts to be joined in a range of 50 μm to 150 μm, the focal diameter of the deep welding laser beam component lies in a range of 40 μm to 100 μm.

30. The method according to claim 16, wherein with a material thickness of the material of the parts to be joined in a range of 50 μm to 150 μm, the focal diameter of the deep welding laser beam component lies in a range of 40 μm to 100 μm.
